(19) United States
(12) Patent Application Publication
(10) Pub. No.: US 2002/0054797 A1
(43) Pub. Date: May 9, 2002

(54) Rotary Cutter

(76) Inventors: Brian Gascoyne, Sheffield (GB); Michael John Kaye, Sheffield (GB)

Correspondence Address: RICHARD ALLEN GIANGIORGI, TRXLER, BUSHNELL, GIANGIORGI & BLACKSTONE LLP, SUITE 3600, 105 W. ADAMS STREET, CHICAGO, IL, 60603, US

(21) Appl. No.: 09/864,810

(22) Filed: May 24, 2001

(30) Foreign Application Priority Data
May 27, 2000 (GB) 0012907.2

(51) Int. Cl. B23B 51/10

(52) U.S. Cl. 408/81; 408/201

(57) ABSTRACT

A rotary cutter (A) adapted to open a pre-drilled hole to a larger diameter, comprises a shank (3) of industry-standard external profile adapted to fit into a chuck, arbor, etc of a drilling machine, a co-axial cutting section (5) extending from the shank (3) and a co-axial, non-cutting pilot boss (9) extending from the cutting section (5), the latter being of the required larger diameter (D) for the pre-drilled hole, and the pilot boss (9) being of smaller diameter (d) and, hence, undersize with respect to the pre-drilled hole.

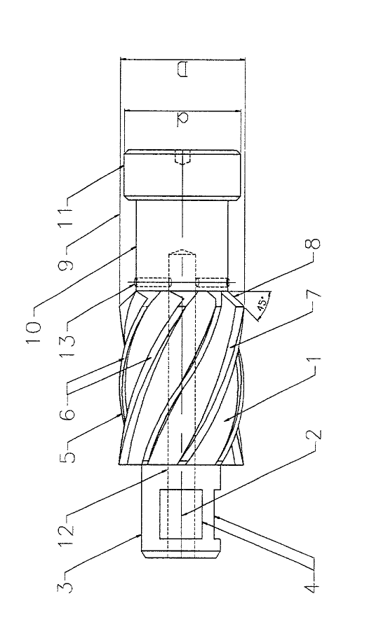

### FIELD OF THE INVENTION

This invention relates to a rotary cutter for use in opening, or over-sizing, pre-drilled holes.

### BACKGROUND OF THE INVENTION

In the jointing of railway rails with fish plates, the standard system is to drill two or three spaced holes, on site, in rail web adjacent the ends of the rails to be joined, with two fish plates having four or six suitable spacer holes applied to opposite sides of the rail webs to bridge the rail ends so that four or six bolts may be inserted through the aligned holes and secured by nuts.

Over a substantial number of years, wide tolerances have previously been permitted in the drilling of the rail webs, not only as to hole diameter, but also as to axial location along the rails, while, after some years service, hole deformation, and particularly elongation frequently occurs, all resulting in a propensity for the propagation of unwelcome cracks, which, if undetected, eventually lead to the break off of the rail end, which breakage, if also undetected could lead to damage of rolling stock or, at worst, derailment.

A technique known in the aircraft industry for stress relieving drilled holes involves cold deformation of an annular zone around the hole by the drawing (pulling) of an oversize mandrel through a hole, which procedure has been found to reduce the crack propagation by over 90% compared with similar holes that have not been subjected to stress relief by cold deformation. Accordingly, in the UK, a programme has been initiated for the stress-relieving of the holes of all fish plate railway joints. It is not however possible to stress relieve, by cold deformation or local expansion a pre-drilled, “old” hole, as such holes have invariably been deformed and/or rusted in service. Consequently, it is essential to precede cold deformation or local expansion by opening out pre-drilled, “old” holes to the next larger acceptable diameter, by use of a cutter. It will be appreciated that the ground level location of “old” holes, eg in the rails of rail track, does not assist the ready location of the lead end of an enlarging cutter into an old hole, particularly during favoured night time working to minimize interruption to rail traffic, nor the orthogonal location of the cutter axes with respect to the central plane of a workpiece such as a rail web.

### OBJECT OF THE INVENTION

A basic object of the present invention is the provision of an improved cutter for use in opening or over-sizing pre-drilled holes, as part of stress relieving operations, particularly fish plate holes of railway rails.

### SUMMARY OF A FIRST ASPECT OF THE INVENTION

According to the present invention there is provided a rotary cutter adapted to open a pre-drilled hole to a larger diameter, comprising a shank of industry-standard external profile adapted to fit into a chuck, arbor etc of a drilling machine, a co-axial cutting section extending from the shank, and a co-axial, non-cutting pilot boss extending from the cutting section, the latter being of the required larger diameter for the pre-drilled hole, and the pilot boss being of smaller diameter and hence undersize with respect to the pre-drilled hole.

### ADVANTAGES OF THE INVENTION

As indicated previously, the cutter in accordance with the invention is intended to open or over-size a pre-drilled, “old” hole, (that has frequently elongated and/or rusted) to a larger diameter, with the cutter, in practice being fitted into a drilling machine clamped to a workpiece such as the web of a railway rail, the presence of which machine further obscures the holes to be opened. However, the provisions of the undersize pilot boss results in the cutter being easily engageable in the “old” hole, even if the “old” hole is in an obscure or relatively inaccessible location so that any delays in cutter location are eliminated, and consequently maximum machine use and minimum down time can be achieved. Typically, an original 28 mm diameter “old” hole may be opened or over-sized to a 30 mm diameter hole. Once an “old” hole has been opened to a new, known size, a mandrel may be engaged in the (enlarged) hole and be drawn therethrough from one side of the rail web to the other, so as to effect cold expansion of the “new” hole so as to substantially reduce, if not eliminate, the propensity for crack propagation.

### SUMMARY OF A SECOND ASPECT OF THE INVENTION

According to a second aspect of the invention, there is provided a set of cutters in accordance with the first aspect, each with differently sized cutting section diameters, so that the most appropriate diameter for opening an old hole may be selected by the user.

Because, in the past, in the UK railway industry a range of hole sizes was permitted, eg 28, 29, 30 or 31 mm, then a track gang arriving at a particular fish plate joint has no idea whether it will find that the original holes were drilled at 28, 29, 30 or 31 mm, much less does it know the extent of any elongation or deformation. Consequently, the provision of a set of eg four, cutters each with a different cutting section diameter, enables, in most, if not all cases, the ready selection of a suitable cutter.

If, for example, a 28 mm diameter “old” hole is not particularly distorted, then a 30 mm cutter will suffice to produce the “new” hole. However, for a 28 mm diameter hole that has been severely elongated, a 30 mm diameter cutter may be unable to ‘clean up’ the old hole, in which case the 32 mm cutter would be used to open the “old” 28 mm diameter hole to a new 32 mm diameter.

### PREFERRED OR OPTIONAL FEATURES OF THE INVENTION

The pilot boss has an external diameter of 27.9 mm, 28.9 mm, 29.9 mm or 30.9 mm.

The pilot boss has an axial length of 12 mm.

The pilot boss has a necked portion.

The necked portion has an axial length of 22 mm.

The pilot boss is integral with the cutter.

The pilot boss is removable from the cutter.

The pilot boss has chamfered ends, eg at 45° to the cutter axis of rotation.

The necked portion extends co-axially from the cutting section to a boss portion that is diametrically undersize for the old hole, for instance a 27.9 mm boss is suitable for an old 28 mm diameter hole.

The cutter section is provided with multiple helical flutes, typically four.

The leading end of each flute has a cutting edge at 45° or thereabouts to the longitudinal axis of the cutter, which edges effect the primary opening of the pre-drilled hole, with the remaining length of the cutter section effecting a cleaning, sizing or reaming action.

An axial bore is drilled into the shank as far as the leading edges of the flutes, where two radial cross holes are drilled at 90° to one another to intersect the terminal end of the axial bore, whereby coolant and/or lubricant may be deposited at the leading edges of the flutes via the axial bore and the cross bore.

In the set of four cutters in accordance with the second aspect intended to open out predrilled holes of original diameters of 28, 29, 30 and 31 mm, diameters for the cutting sections are 30, 31, 32 and 33 mm, with bosses of 27.9, 28.9, 29.9 and 30.9 mm diameter.

### BRIEF DESCRIPTION OF THE DRAWING

The invention will now be described in greater detail by way of example, with reference to the accompanying drawing, which is a side elevation of one example of cutter in accordance with the first aspect.

### DETAILED DESCRIPTION OF THE DRAWING

In the drawing is shown a rotary cutter 1 intended for opening out pre-drilled “old” holes, typically in railway rails, to a slightly larger diameter in preparation for a subsequent stress-relieving step by drawing a mandrel through the enlarged hole to effect cold deformation/local expansion to achieve stress relief.

The cutter 1 has a longitudinal axis of rotation 2 and is provided at one end with an industry-standard shank 3, having flats 4, by which the shank, and hence the cutter, may be drivably secured in an industry-standard chuck or arbor.

A co-axial cutting section 5 extends from the shank 3 and has four flutes 6, with a leading end 7 of each flute having cutting edge 8 at 45° to the axis 2. The cutting section 5 has a diameter ‘D’ required for the enlarged hole.

A non-cutting pilot boss 9 extends co-axially from the cutting section 5, and comprises a necked portion 10 and a boss portion 11 or diameter ‘d’ that is undersize with respect to the pre-drilled hole that it is required to open out, and hence of a diameter that will fit with ease into a pre-drilled hole.

An axial bore 12 is drilled through both the shank and the cutting section 5, into the necked portion 10. Two radially extending cross holes 13, at 90° to each other, are drilled into the cutting section 5, adjacent to the necked portion 10.

What we claim is:

1. A rotary cutter having an axis of rotation and adapted to open a pre-drilled hole to a larger diameter, comprising a shank of industry-standard external profile adapted to fit into a chuck, arbor, etc of a drilling machine, a co-axial cutting section extending from said shank and a co-axial, non-cutting pilot boss extending from said cutting section, said cutting section being of the required larger diameter for said pre-drilled hole, and said pilot boss being of smaller diameter and, hence, undersize with respect to said pre-drilled hole.

2. A cutter as claimed in claim 1, wherein said pilot boss has an external diameter of 27.9 mm, 28.9 mm, 29.9 mm or 30.9 mm.

3. A cutter as claimed in claim 1, wherein said pilot boss has an axial length of 12 mm.

4. A cutter as claimed in claim 1, wherein said pilot boss has a necked portion.

5. A cutter as claimed in claim 4, wherein said necked portion has an axial length of 22 mm.

6. A cutter as claimed in claim 1, wherein said pilot boss is integral with said cutter.

7. A cutter as claimed in claim 1, wherein said pilot boss is removable from the cutter.

8. A cutter as claimed in claim 1, wherein said pilot boss has chamfered ends, eg at 45° to rotation of said cutter.

9. A cutter as claimed in claim 4, wherein said necked portion extends co-axially from said cutting section to a boss portion that is diametrically undersize for said pre-drilled hole.

10. A cutter as claimed in claim 1, wherein said cutter section is provided with multiple helical flutes.

11. A cutter as claimed in claim 10, wherein said cutter section is provided with four flutes.

12. A cutter as claimed in claim 10, wherein a leading end of each of said flutes has a cutting edge at 45°, to the axis of rotation of said cutter, which edges effect a primary opening of the pre-drilled hole, with the remaining length of the cutter section effecting a cleaning, sizing or reaming action on said hole.

13. A cutter as claimed in claim 12, wherein an axial bore is drilled into said shank as far as said leading edges of said flutes, where two radial cross holes are drilled at 90° to one another, to intersect a terminal end of said axial bore, whereby coolant and/or lubricant may be deposited at said leading edges of said flutes via said axial bore and said cross bore.

14. A set of cutters in accordance with claim 1, each with differently sized diameters of said cutting sections, so that the most appropriate diameter for opening a pre-drilled hole may be selected by the user.

15. A set of cutters as claimed in claim 14, wherein, in a set of four cutters intended to open out pre-drilled holes of original diameters of 28, 29, 30 and 31 mm, diameters for said cutting sections are 30, 31, 32 and 33 mm, with said bosses of 27.9, 28.9, 29.9 and 30.9 mm diameters.
